(19) United States
(12) Patent Application Publication
(10) Pub. No.: US 2009/0297811 A1
(43) Pub. Date: Dec. 3, 2009

(54) Single-Layer Slip-Resistant and Moisture-Absorbent Composite and Exercise Mat

(76) Inventor: Shawn Robert Hutchinson, Fuquay Varina, NC (US)

Correspondence Address: Shawn Robert Hutchinson, 1608 Eagon Court, Fuquay Varina, NC, 27526, US

(21) Appl. No.: 12/131,855

(22) Filed: Jun. 2, 2008

(51) Int. Cl. B32B 5/02; A63B 6/00; C08L 1/02

(52) U.S. Cl. 428/220; 428/195.1; 524/35

(57) ABSTRACT

This invention relates to composites and exercise mats, specifically to such mats that provide surface traction on top and bottom surfaces using a single layer material.

### CROSS-REFERENCES TO RELATED APPLICATIONS

This document references but does not claim the date of a Provisional Patent Application 60/440,917 with filing date Jan. 17, 2003 by Shawn R. Hutchinson of 1608 Eagon Court/Fuquay-Varina, N.C. 27526.

### FIELD OF INVENTION

The majority of today's exercise mats are composed of synthetic foam materials as they can be made for various thickness and they provide top and bottom tacky surfaces. The bottom surface prevents the mat from sliding on floor surfaces. The top surface sometimes provides a slip-resistant surface for longitudinal forces, or forces that are exerted on a plane parallel to the surface of the mat whereby the mat provides friction to hinder or stop the force.

The most ubiquitous form of exercise mats currently in production is the “Sticky Mat.” U.S. Pat. No. 6,491,196 to Coler (2000) defines a ‘Sticky Mat’ as, ‘typically 24″×72″ and is made of a textured rubber (synthetic) material with a special coating to create a slip-free or sticky finish. The yoga mat is usually rolled into a cylinder and carried to and from the center where yoga is practiced. The diameter of the typical rolled-up yoga mat is approximately 4.5″ and the height remains 24″.’ There is no specific patent for this mat. Presumably, its utility is a prior art found in previous patents. The only improvements to the Sticky Mat have been new chemical mixtures and thicker layers.

Traditional materials used to make these mats are based on polyvinyl chloride (PVC). PVC is naturally hard material that is made plastic through plasticizers such as heavy metals and phthalate esters. These materials are generally known to have biocompatibility concerns. Although they do not generally appear to bring about acute allergic reactions or toxicities, for industries geared to improving the well-being of an individual, these types of synthetic chemicals are undesirable. Furthermore, when considering a cradle-to-cradle design paradigm, they are difficult to recycle and even in landfills can be toxic when disposed. Having a high performance exercise mat without the use of PVC and harmful plasticizers is clearly advantageous.

PVC-based exercise mats are the de facto standard practice surface for the millions of regular American hatha yoga practitioners. The sticky mat provides a lightweight slip-resistant surface in dry conditions. However, this mat has inherent performance drawbacks and longstanding biocompatibility concerns.

‘Postures’ or asana-styles demand different properties from the standard exercise mat. The amount of perspiration generated by practitioners varies by style and athletic ability. In both cases the individual requires a slip-resistant practice surface. Standard foamed closed-cell PVC mats and cotton rugs provide insufficient properties in wet and dry conditions.

This study investigates changes in the ability of a mat to resist slippage upon absorption of water for the PVC mat, cotton rug and a novel slip-resistant and absorbent fibrous material. Dynamic coefficients of friction as a function of absorbed water are examined. The efficacy of each mat to resist slippage with absorbed water is correlated to expected sweat generation during practice. A prior predictive sweat loss response model to metabolic rate, environment and clothing is used.

Polyvinyl chloride is a soft material lauded for its inertness and subject to longstanding biocompatibility and environmental concerns. Various plasticizing agents used to modify the polymer behavior of the inexpensive material are also considered questionable. Yet today PVC petrochemicals are the second largest class of thermoplastics spanning the consumer marketplace from plumbing to children's toys.¹⁻⁴

PVC found its way into the exercise and sporting goods industry as yoga mats in the 1970s. Hatha yoga ‘postures’, or asanas, comprise a subset of one of at least six paths of Indian yoga ranging from devotion (bhakti) to knowledge (jnana). The word yoga itself translates loosely as ‘yoke’ or ‘union,’ describing ways to integrate the physical, mental and spiritual aspects of human existence. This system was most recently brought to the west in the 1950s and 1960s. Subsequently, hatha yoga has diverged into many styles catering to many types of practitioners. As of 2002, an estimated 18 million Americans practice some form of asanas, or the misnomer ‘yoga’.⁴

In India, asanas are traditionally practiced on a thin cotton rug or a dirt floor. Yet in the west, practitioners found this material an insufficient means of providing traction that maximizes grip while preventing slippage.⁵

Numerous styles of asanas have emerged since the general yoga diaspora in the mid 20^{th} century. Table 1 outlines popular types associated by physical difficulty. Students experience a range of practice conditions. More vigorous styles create substantial amounts of perspiration. Gentle to moderate difficulties tend to generate less. The amount and rate of perspiration varies by individual, instructor, and style. A typical session lasts for 30 minutes to 2.5 hours and can generate over 1 liter of perspiration.

For those who do not sweat, a synthetic sticky mat gives sufficient traction. For those who perspire even slightly, it offers little to no grip. For vigorous styles, perspiration can be moderate and this group uses cotton rugs. However, when wet the rug yields limited traction and does not resist slipping on smooth floor surfaces.

TABLE 1
Popular styles of western Hatha yoga⁶

| Style | Description |
|---|---|
| Astanga | Vigorous |
| Bikram | Moderate, hot |
| Kundalini | Gentle |
| Iyengar | Moderate |
| Sivananda | Moderate |
| Viniyoga | Gentle |
| Vinyasa | Vigorous |

Raw, PVC is a hard material that softens and shrinks at relatively low temperatures. A range of degradation mechanisms including thermal, chemical, photolysis, and irradiation yield a variety of often harmful byproducts.⁷⁻¹² Most notable are hydrogen chloride and chlorinated benzenes, notably dioxins.^{3,13} To alter the behavior of the material, plasticizers such as di(2-ethylhexyl) phthalate (DEHP), diisononyl phthalate (DINP) and heavy metal compounds (lead, cadmium, mercury, zinc, tin & barium) have been used to stabilize and yield a variety of behaviors.¹⁴ Plasticizing agents and products of degradation fuel the regulations for health and environmental concerns surrounding the manufacture, consumption and disposal of plasticized PVC.¹⁵⁻¹⁷

The Delaney Clause of the U.S. Food, Drug and Cosmetic Act of 1958 states, “no additive shall be deemed to be safe if it is found . . . to induce cancer in man or animal . . . ” Not until angiosarcoma (liver cancer) and what was later labeled the ‘PVC Disease’ were traced to autoclave vinyl chloride workers in the early 1970s did the U.S. Food and Drugs Administration regulate the amount of human contact.¹² A proposed regulation issued in September 1975 permitted continued use of PVC in contact with foodstuffs, “where the potential for migration of vinyl chloride is diminished to the extent that it may not reasonably be expected to become a component of food”.¹⁸

TABLE 2
Oekotex 100 Certified, Chemical Limits of
Sticky Mats by Simply Yoga, London, UK¹⁹

| Attribute | Value | |
|---|---|---|
| pH | 4.0-7.5 | |
| Formaldehyde | 75 | ppm |
| Extractable heavy metals | 92 | ppm |
| (arsenic, lead, cadmium, chromium, etc.) | | |
| Mercury | 0.02 | ppm |
| Pesticides | 1 | ppm |
| (DDT, Lindane, Hexachlorobenzene) | | |
| Phenols | 2 | ppm |
| Organic tins | 1 | ppm |
| Chlorobenzenes and chlorotoluenes | 1 | ppm |

| | |
|---|---|
| Biocides | None |
| Forbidden flame retardants | None |

One of the more recent controversies surrounding the use of plasticized PVC in consumer products came with DINP in children's toys. Of particular interest were teething rings imported from China, which contained 40-50% by weight. In early 1997, a Danish ban led to efforts from various EU countries to control or limit toys containing DINP. Greenpeace's ‘Exeter Report’ of 1997 re-initiated worldwide controversy over the hazards of PVC and compositions plasticized with DINP. After a series of tests by Health Canada, Greenpeace and the National Environmental Trust petitioned the US Consumer Product Safety Commission (CPSC) to ban the material in related applications. Yet effects of low-level exposures for short durations may not induce acute symptoms.¹⁴ As a result, rather than banning, the CPSC issued a request for manufacturers to discontinue production of consumer products containing DINP. In the EU, however, a recent directive phases out or controls the use of DINP in many plasticized PVC toys.

Despite the controversies, PVC growth continues. The largest growth is shown in developing Asian countries where lack of social awareness and environmental regulations enable its unfettered expansion. In 2002, expected North American production of PVC was 9,350,000 metric tons with a slowing average annual growth rate of 4%. Compared with Asia, 12,920,000 metric tons with a 12% growth rate had doubled capacity in 5 years. In general, usage of PVC continues where lightweight, durable, and economic materials are needed.^{2,20}

At single high-dose exposures, many PVC plasticizing and filler chemicals are known or suspected carcinogens. Reactions from chronic low-level exposures are not as well understood.¹⁴ Before an assertion is made about the toxicity of PVC sticky mats, accurately identifying the contents is critical. Table 2 shows tested levels of toxic chemicals in a Oekotek 100 Certified sticky mat by Simply Yoga, London, UK. Phthalate and other plasticizers are not included in this test. Toxic contents of other commercial sticky mats are not publicly available. In fact, Hugger Mugger (Salt Lake City, Utah, USA), marketer of the most popular PVC ‘sticky’ mat the Tapas® Mat, makes no public disclosure about the contents, other than it is PVC based.

### BACKGROUND ART

U.S. Pat. No. 4,147,828 to Heckel (1977) shows a uniformly 3-layer exercise and tumbling mat of a plurality of soft elastic synthetic foam layers laminated together with one or more top textile layers and a nonskid mesh netting on the underside. This mat should be considered a traditional utility for providing body cushioning and restricted stability during basic exercises.

US Patent Application 20010011399 pending for Blum (2001) shows a multi-component cushioned floor mat system that includes customized graphics, transparent cleanable portion and antibacterial/antifungal composition. While Blum does demonstrate a method of producing a multi-layered non-slip floor covering, this variation provides separate layers for cushioning and cleaning, a wholly separate cleanable transparent layer, and a system of achieving a tacky surface cleanable only by eroding layers rather than a uniform coating of persistent density. This floor mat is to be considered solely for the intent of wiping one's shoes.

US Patent Application 20020098947 pending for Brown (2002) shows a uniformly 3-layer non-slip mat that is broadly general in its description of an exercising and sports conditioning mat. The layers consist of: 1) a multi-purpose non-slip top layer with surface alphanumeric alignment indicium, 2) a layer of shock-absorbing material and 3) a bottom layer of non-sliding material. This mat should be considered an improvement of the mat outlined in U.S. Pat. No. 4,147,828 whose improvement is limited to the alignment indicia.

US Patent Application 20020114926 pending for Malpass (2002) shows a multi-layered slip-resistant floor mat that incorporates a plurality of recessions with inset suction cups in the bottom surface of the bottom layer. This is a variation on a non-slip floor covering that utilizes two-section suction cups to fix the mat to the floor whose top part is a pillar that is connected to the bottom cup. The pillars would create a hindrance and nuisance to a Practitioner, as s/he requires a completely smooth and uninterrupted surface during any full or partial body contact with the mat during their routine for undistracted exercise. The pillars would locally restrict the level of cushion-ability. This mat is intended for floor coverings, not an exercise program.

Despite the flexibility of the prior-art exercise mat designs, they all suffer from a number of disadvantages:
(a) Use of plasticizing agents that are potentially harmful to life and the environment;
(b) Any exercise Practitioner is subject to perspiring during the program. When perspiration occurs, it can puddle on the surface of any synthetic mat causing the body to slip when exerting longitudinal pressure. This creates an environment where injury can occur from slipping and disrupts the flow of a routine if the Practitioner must pause to clean off the mat;
(c) The nature of a synthetic mat as with any plastic derivative is to insulate. Foam cannot transfer perspiration and heat away from the surface, thereby offering no way of preventing the Practitioner's body from overheating. To combat this defect of synthetic mats, some use thin cotton textiles or even towels to provide absorption for the perspiration. This solution is not only cumbersome because it requires multiple articles, but also is aesthetically unappealing;
(d) For others, practicing on a synthetic mat is not the most desirable choice. They have gotten used to the slip-resistant features of the synthetic mats tackiness. Unfortunately, there is no fibrous material product that also offers a suitable tacky top surface;
(e) Many people have reported unpleasant odors from their mats. Synthetic foam tends of permanently absorb odors after long-time use; and
(f) The current textiles on the market cannot be used alone because they are too thin and they slip on smooth surfaces.

### SUMMARY

In accordance to the present invention, an exercise mat comprises a single layer composite material with an overall coefficient of friction greater than unity. The constituents comprise materials having coefficient of friction of about unity and greater than unity. The material with the coefficient of friction greater than unity is referred to as the slip-resistant material. Top and bottom surfaces both provide resistance to slipping. Specifically in the mat embodiment the material provides sufficient cushioning and an absorbable surface to prevent injury during exercise routines.

Rather than the expensive process of laminating multiple layers of material together to provide sufficient cushioning, the Slip-Resistant Composite Material and Exercise Mat utilizes additional strands of fiber, filament, yarn, or material that provide the thickness previously not found in any exercise mat or fibrous material. The instant embodiments are the first product to do so.

The slip-resistant materials with a coefficient of friction of greater than unity comprises one or more natural and synthetic rubbers, plastics, and elastomers. The moisture-absorbent materials with a coefficient of friction of about unity include those from natural and synthetic sources. Natural sources of moisture-absorbent materials include cellulose, cotton, flax, linen, hemp, jute, and kenaf. Synthetic versions of moisture-absorbent materials comprise rayon, bamboo, nylon, polyester, polyethylene, polypropylene, acrylic, or blends thereof.

The composite material comprises materials in various shapes or profiles. The material(s) having a coefficient of friction greater than unity can be molded into any suitable profile or shape, such as a fiber, filament, cord, tape, miscible blend, immiscible blend, or blends thereof. The material(s) having a coefficient of friction of about unity can be molded or formed into any suitable profile or shape, such as a fiber, filament, cord, tape, miscible blend, immiscible blend, or blends thereof. The materials with different coefficients of friction can be combined, mixed, or blended.

The composite can be formed through any means of molding, extrusion, pultrusion, weaving, knitting, or nonwoven processing.

The constituents of the composite material or the material itself can be dyed, pigmented, printed, or otherwise colored. Patterns can thus be incorporated into or imparted onto the material. For instance, alignment patterning can be achieved through colored warp and/or weft yarns. Or during extrusion colored patterns can be co-extruded. Patterns from embossing and applique techniques such as printing can form color onto the material after it is formed. Other compounds can be used in the materials including but not limited to perfumes, odor sequestrates or enhancers, antibacterials, antifungals, UV absorbers, texturizers, finishers, plasticizers, and processing agents. These can be encapsulated, particulate, liquid, or mixtures thereof and sprayed, coated, blended, or mixtures thereof.

The exercise mat embodiment of the invention has conventional dimensions of a width of about 30-cm to about 100-cm, a length of about 100-cm to about 250-cm, and a depth of about 0.1 to about 5-cm. These vary according to the type of exercise routine, the amount of cushioning desired (less cushioning is often preferred by more advanced practitioners), the weight of the mat (a mat to keep at the studio or one with which to travel), and the size of the person practicing (whether for instance the practitioner is an large man, small woman, or child).

Fully synthetic mats are often difficult to care for, and are therefore not washed frequently in studios. Hygiene obviously becomes a problem as numerous people use the same mats on even a daily basis. But to date a mat that provides the same degree of traction but is capable of being easily washed is not available. The materials for the exercise mat can be chosen such that the mat is machine washable and dryable—such as cotton and natural rubber. Pre-shrunk yarns and stabilized latex provide a mat that is dimensionally stable during washing and drying in machines.

The combination of rubber and cotton, for instances, without being limited by theory, appears to provide a cooling thermal mechanism whereby the properties of the natural materials act like a heat sink and prevents the Practitioner from overheating. In contrast, the synthetic and rubber materials in conventional mats simply reflect body heat and can disadvantageously (depending on the style yoga) cause the practitioner to sweat. The most preferred instant design balances slip resistances and heat reflection (materials with a coefficient of friction greater than unity) with moisture absorption and heat absorption (materials with a coefficient of friction of about unity) according to the application of the composite such as for exercise or covering a surface.

Furthermore, none of the prior-art mats addressed the need for only reduced areas of a tacky top-surface. In most forms of Yoga, a tacky top surface is only required in specific areas. There are additional embodiments that yield top-layer non-slip functionality outlined in this document:
(a) Detachable scrim coated with a slip-resistant material placed over the top layer of the mat located where one requires additional traction when in postures or positions that require extra coefficients of friction to prevent longitudinal slipping;
(b) Detachable strips of high friction materials such as those that provide outdoor traction on steps in wet conditions; and
(c) Application of a slip-resistant material to its surface in areas requiring additional traction support.

For the purpose of this document, a uniform single layer is hereby defined as: a separate and distinct part of the composite exercise mat of width and breadth whose depth is necessarily less than the total depth of said floor covering. The layers are combined through lamination, disposition, or other chemical adhesion.

### DRAWING FIGURES

FIG. 1 shows a basic fibrous material coated with a backing of latex

FIG. 2 shows a basic fibrous material with detachable or attached traction bands

FIG. 3A shows an uncoated yarn strand.

FIG. 3B shows a coated yarn strand

FIG. 3C shows a single-layer slip-resistant composite material

FIG. 4 Slip Force by Load, Tapas® Mat

FIG. 5 Slip Force by Load, cotton rug

FIG. 6 Slip Force by Load, Yoke Mat™

FIG. 7 Threshold Slip Forces by Load

Reference Numerals in Drawings

| | | | |
|---|---|---|---|
| 10 | core textile layer | 12 | slip-resistant coating |
| 14 | slip-resistant mesh | 16 | core yarn strand layer |
| 18 | slip-resistant strand | 20 | single-layer slip resistant woven |

### DESCRIPTION

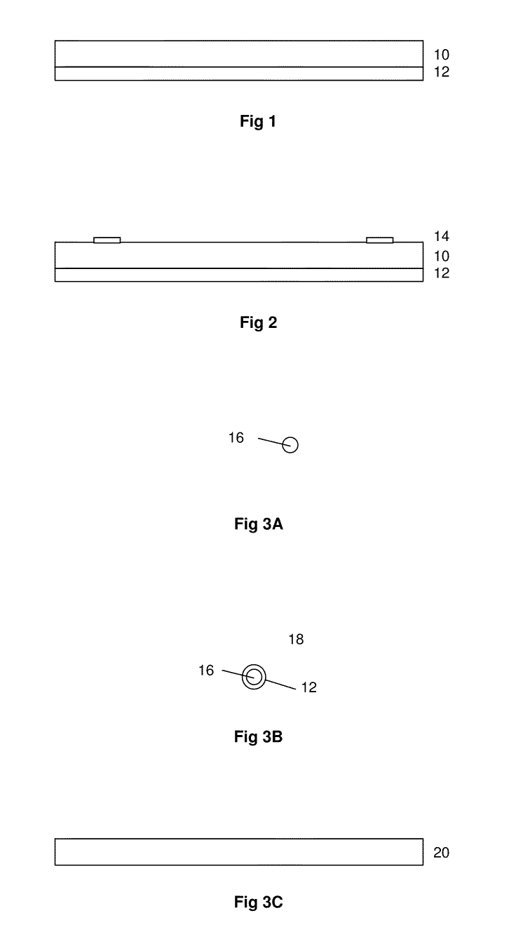

### FIG. 1—Basic Embodiment

The basic embodiment of the Slip-Resistant Composite Material and Exercise Mat is illustrated in FIG. 1. The mat has a core textile layer 10 comprising twisted and woven yarn and/or threads. Multiple layers of textile can be attached together by lamination or stitching.

The exploded lateral cross section of the mat has a core textile layer 10 comprised of twisted and woven yarn or threads. A layer of slip-resistant coating 12 is disposed on the bottom side of base 10. In this basic embodiment, the coating consists of liquid latex rubber available as FIBER-LOK from ETI of Fields Landing, Calif. and on any commodity market. However, the base can consist of any other material that is flexible and provides a tacky surface, such as liquid synthetic rubber. Other backings can also be laminated or stitched, such as pre-formed slip-resistant webbing, pre-cast rubber molds, etc.

To apply, place the textile on a flat surface. Optimal results occur using two separate coatings. Brush or roll, using a standard paint sponge roller, a thin, even coat of liquid latex rubber. Two thin coats are better than one heavy application. Latex rubber is transparent when dry and ready to be re-coated. The second coat should be applied within 12 hours of the first. Clean the brush with soap and water. Allow one week before washing rug.

Partial coatings can be done locally or through machine application. Variations include full coating or spraying. Further, other ways of reducing the amount of material include a machine-applied array of slip-resistant dots, as found in standard gardening gloves.

### FIG. 2—The Secondary Embodiment

The secondary, or improved embodiment of the Slip-Resistant Composite Material and Exercise Mat with Detachable Slip-Resistant Scrims is illustrated in FIG. 2. The core textile layer 10 comprises twisted and woven yarn or threads. Multiple layers of textile or material can be attached together by lamination or stitching such as pre-formed slip-resistant webbing and pre-cast rubber molds. Placed at the user's discretion are two detachable slip-resistant meshes or rubber permanently applied directly to the mat 14 that provide top surface traction while allowing for perspiration to be passed through the webbing or around the band, which is absorbed by the core layer 10. The mesh bands can also be looped around the core textile to secure them better in place.

To prepare the detachable mesh, cut a piece of cotton gauze scrim long enough to encircle the mat on both sides. Strips of at least six inches wide work best, but the size depends on the total area coverage desired. With liquid latex rubber in a wide and shallow pan, simply dip gauze on the surface. The latex will tend to cover the mesh holes, so firmly shake the gauze to keep the holes between the warp and weft threads open. This procedure reinforces the gauze and forms natural webbing. Hang dry. In order to seal the ends together, after the first coating is dry, reapply a small amount to the longitudinal ends and press firmly together. Secure with clothespins and hang dry.

### FIGS. 3A, 3B, & 3C—The Preferred Embodiment

The preferred embodiment of the Slip-Resistant Composite Material and Exercise Mat is illustrated in FIG. 3A-3C. The mat has a core yarn layer 16 comprised of twisted and woven yarn and/or threads. To prepare the slip-resistant strands, submerge the yarn or threads completely in liquid latex rubber and allow them to saturate. This forms a coating about the core layer 12 and a composite slip-resistant material 18. Liquid latex rubber is available as FIBER-LOK from ETI of Fields Landing, Calif. and on any commodity market. Substitutes may be derived from liquid synthetic rubber or other fibers that have slip-resistant characteristics inherent to their material properties such as elastic cord. Remove the strands and allow excess to drip away. Drape strands over a clothesline to dry allowing them not to touch each other. When dry, twist coated and uncoated strands together. Wind on bobbin, load in shuttle, and weave as normal.

This forms a single layer slip-resistant woven composite 20. Alternatively, the coated strands can be introduced in alternative weft picks, or as warp yarns, in any fashion to exposes the slip-resistance in a manner suited to providing traction on both surfaces of the mat.

TABLE 3
Comparatives Advantages and Disadvantages of Exercise Mats

| Mat Embodiments | Advantages | Disadvantages |
|---|---|---|
| Traditional Indian Yoga | 1. absorbs perspiration. | 1. slips on floor. |
| Textile | | 2. uncomfortable thickness. |
| | | 3. slipping on top surface. |
| Quilted Yoga Textiles, | 1. absorbs perspiration. | 1. slips on floor. |
| | | 2. labor intensive. |
| | | 3. shorter product life. |
| | | 4. slipping on top surface. |
| Yoga Textiles | 1. absorbs perspiration. | 1. slip on floor. |
| | | 2. uncomfortable thickness. |
| | | 3. slipping on top surface. |
| Sticky Mat | 1. stays in place on floor. | 1. perspiration pools on |
| | 2. top surface prevents | surface. |
| | slipping in some cases. | 2. slipping on pooled |
| | 3. variety of thickness | surface. |
| | | 3. absorbs unpleasant |
| | | odors. |
| Sticky Mat with household | 1. stays in place on floor. | 1. absorbs unpleasant |
| towel | 2. absorbs perspiration. | odors. |
| | 3. variety of thickness. | 2. cumbersome. |
| | | 3. no aesthetic value. |
| Textile layer with slip- | 1. thermal mechanism. | |
| resistant coating on | 2. stays in place on floor. | |
| bottom side | 3. variety of thickness. | |
| | 4. reduces slipping on top | |
| | surface. | |
| | 5. as heavy as equivalent | |
| | Sticky Mat thickness. | |
| Textile layer with partial | 1. thermal mechanism. | |
| slip-resistant coating on | 2. stays in place on floor. | |
| bottom side | 3. variety of thickness. | |
| | 4. uses less slip-resistant | |
| | material. | |
| | 5. reduces slipping on top | |
| | surface. | |
| | 6. as heavy as equivalent | |
| | Sticky Mat thickness. | |
| Textile layer with slip- | 1. mat stays in place on | 1. perspiration pools (though |
| resistant coating on | floor. | some may not perspire). |
| bottom and full slip- | 2. variety of thickness. | 2. slipping on pooled |
| resistant coating on top | 3. full traction on top | surface. |
| | surface. | 3. aesthetic discoloration. |
| Textile layer with slip- | 1. thermal mechanism. | 1. hand and foot slipping |
| resistant coating on | 2. stays in place on floor. | possible if perspiration |
| bottom and sectional slip- | 3. variety of thickness. | pools. |
| resistant coating on top | 4. uses less slip-resistant | 2. aesthetic discoloration. |
| | material. | |
| | 5. top surface traction | |
| | strategically placed for | |
| | higher stress areas. | |
| Textile layer with slip- | 1. thermal mechanism. | 1. additional labor costs for |
| resistant coating on back | 2. stays in place on floor. | attaching scrim. |
| and attached top layer | 3. variety of thickness. | 2. scrim can be accidentally |
| slip-resistant scrim | 4. top surface traction | torn off. |
| webbings | strategically placed for | 3. fixed scrim placement. |
| | higher stress areas. | 4. fixed scrim size. |
| | 5. open mesh scrims allow | |
| | absorption for appendage. | |
| Textile layer with slip- | 1. thermal mechanism. | |
| resistant coating on back | 2. stays in place on floor. | |
| and detachable top layer | 3. variety of thickness. | |
| slip-resistant scrim | 4. top surface traction | |
| webbings | strategically placed for | |
| | higher stress areas. | |
| | 5. user places top surface | |
| | traction. | |
| | 6. variable scrim sizes. | |
| | 7. open mesh scrims allow | |
| | absorption for hands and | |
| | feet | |
| Textile layer woven with | 1. thermal mechanism. | 1. weaving complications? |
| slip-resistant yarn and/or | 2. stays in place on floor. | (may be overcome with a |
| thread strands, the | 3. variety of thickness. | coating of chalk after slip- |
| preferred embodiment | 4. full top surface traction. | resistant dries that washes |
| | 5. no need for scrim. | off so that it doesn't hinder |
| | 5. substantially less slip- | bobbin preparing or |
| | resistant material. | weaving) |
| | | 2. strain discolorations? (this |
| | | can be alleviated by color & |
| | | size choice of yarn and/or |
| | | thread). |

### Experimentation

Three yoga and exercise mats were used in this experiment: a Tapas® Mat by Hugger Mugger, a Yoke Mat™ by Complete Circle (Fuquay-Varina, N.C., USA), and a cotton rug by Prana (Vista, Calif., USA). The Tapas® mat was composed of plasticized closed-cell foamed PVC. The cotton rug is a weft-faced plain weave cotton rug. The Yoke Mat™ is a proprietary all-natural fibrous material.

A 16.5 cm×61.0 cm piece of each mat was cut and soaked in tap water for 3 hours to establish the maximum absorptive capacity. Mats were tested for slip force at a range of absorbed water from 0 mL to maximum capacity. Table 4 summarizes the capacities and tested amounts.

After the capacity for each mat was established, the mats were allowed to dry for 2 days. The predetermined test water level was evenly applied and allowed to condition for 15 minutes. Once the water was absorbed, the mat was placed on a smooth enamel metallic surface. This simulates the typical wood, ceramic or linoleum floor surface. Concrete and clay bricks were used to apply a specific load over a given area, see FIG. 1. Weight varied from approximately 1.6 to 16.8 kg. A calibrated spring balance by Chantillon's of New York, ca. 1892 was used to measure the amount of force required to induce mat slippage, or slip force (F_{S}). Once all measurable loads for the given absorbance were completed, water was again evenly added such that the total water added equaled the next test level. This iterative cycle was completed once the total capacity was reached.

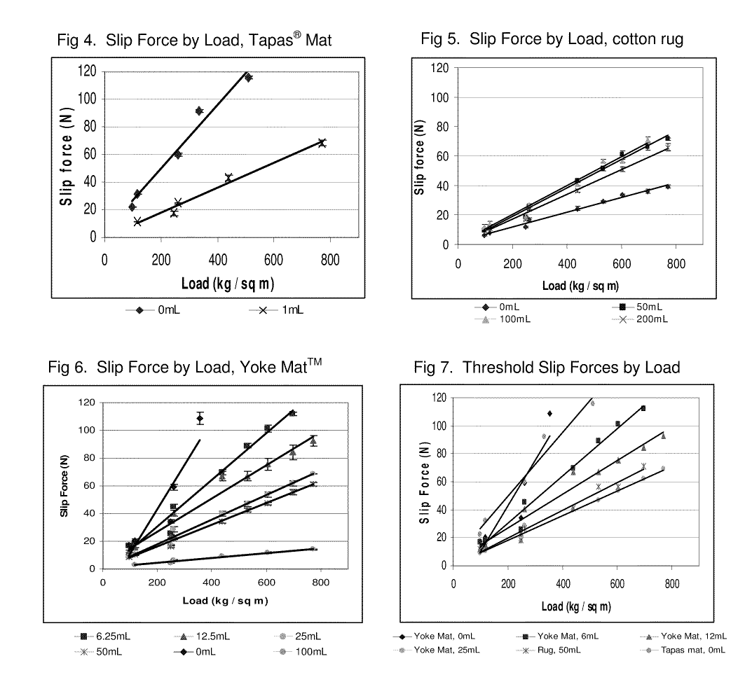

Linear models fit well for each slip force by load curve. The slope is effectively the dynamic coefficient of friction. Plots of F_{S} by load show different trends for each mat, FIGS. 4-7. Table 4 shows slope coefficient, y-intercept and r-square coefficient of determination. Structural and surface changes with absorbed water as well as experimental variation account for the nonzero and negative intercepts. Analyses indicate strong correlations.

The slip force for the Tapas® Mat significantly decreases with small applications of water. The mat itself tears when pulling under high loads. Since the mat absorbs no surface water, a film is produced with application of 1 mL of water. Additional water yield no further reduction in slip resistance. The slip resistance of the cotton rug increases to an observed maximum at 100 mL water. Both 50 mL and 100 mL show similar curve trends. At the 200 mL level, the slope decreases, albeit 70% higher than dry.

The slip force for the Yoke Mat™ shows a wider range of response depending on the load and level of water. Up to 25 mL, small levels of absorbed water show a higher resistance to slippage than wetted PVC. The slope decreases with larger amounts of water.

Each mat shows a similar threshold slip force of approximately 70 N at the maximum load of 770 kg·m⁻². FIG. 7 shows slip forces for all mats at and above 70 N. For the Tapas® Mat, the threshold force is a minimum. For the cotton rug, it is a maximum. The Yoke Mat™ shows an intermediate threshold at 70 N.

TABLE 4
Absorptive Capacity and Tested Amount of Water by Mat Type

| | Mass | Capacity | Tested |
|---|---|---|---|
| Mat | Cotton (g) | (mL) | (mL) |
| Tapas ® mat | 0 | 1 | 0 |
| | | | 1 |
| Yoke Mat ™ | 30 | 100 | 0 |
| | | | 6 |
| | | | 12 |
| | | | 25 |
| | | | 50 |
| | | | 100 |
| Cotton rug | 65 | 200 | 0 |
| | | | 50 |
| | | | 100 |
| | | | 200 |

The commercial success of the Tapas® Mat is due to its demonstrated ability to resist greater slip forces than a wetted cotton rug. This property is advantageous both as a secure foundation on smooth floor surfaces and by providing traction for the practitioner. In a comparison at absorbed water levels of 25% capacity, the basic Yoke Mat™ resists larger slip forces than a cotton rug and wetted Tapas® Mat. The Yoke Mat™ offers resistances to slippage above the threshold at water levels up to 12%.

TABLE 5
Linear correlations of Slip Force by Load

| | Absorbed | | Y- | |
|---|---|---|---|---|
| Mat | water (mL) | Coefficient | intercept | R-square |
| Tapas ® Mat | 0 | 0.2293 | 3.8840 | 0.9692 |
| | 1 | 0.0899 | 0.3196 | 0.9867 |
| Cotton rug | 0 | 0.0499 | 1.8380 | 0.9870 |
| | 50 | 0.0971 | −0.7411 | 0.9897 |
| | 100 | 0.0982 | 0.3191 | 0.9753 |
| | 200 | 0.0845 | 0.1391 | 0.9885 |
| Yoke Mat ™ | 0 | 0.2745 | −8.8784 | 0.8465 |
| | 6 | 0.1680 | −3.0191 | 0.9788 |
| | 12 | 0.1204 | 2.8027 | 0.9625 |
| | 25 | 0.0886 | 0.4124 | 0.9877 |
| | 50 | 0.0787 | 0.2672 | 0.9948 |
| | 100 | 0.0174 | 1.1475 | 0.9789 |

In order to evaluate the viability of the slip-resistant and absorptive fibrous material in practice, an assessment of conditions and expected sweat rate is necessary. The experiments of Shapiro, et al^{21,22} show actual and predicted sweat loss rates for various exercises, environments and clothing for 34 heat-acclimated males. The model adjusts previous models for additional interactions and more accurately predicts sweat loss.

While a majority of yoga practitioners are female, this model provides a framework to extrapolate sweat loss. The study correlates such human parameters as age, weight, height, body surface and body fat with environment conditions of temperature, relative humidity and convection with thermal insulative values of clothing ensembles. Exercise conditions consisted of walking at a speed of 1.34 m·s⁻¹. For the purpose of yoga, the clothing value for shorts is applicable.

The environmental and exercise conditions closely representing the styles of yoga is shown in Table 6. Sweat loss is approximate and adjusted as amounts depend on the individual's athletic ability. The amount of sweat reaching the mat is further dependent on the evaporation rate. In order to compare the actual values for the absorbed water levels in a mat, the sweat loss must be taken in proportion of the body surface area in contact with the mat. This does not apply for heavy perspiration rates where drips are formed. At these levels, rate of transfer of moisture to the mat increases, as does the amount absorbed by clothing. For vigorous conditions, the sweat loss is decreased by the surface area covered by shorts, which compensates for body area whose sweat is absorbed by the shorts. The surface area of mid-thigh-length shorts is 12.01%.

Based on the size of an average western female body, the surface area of hand and foot is 0.009677 m² and 0.01742 m². The total surface area is 0.05419 or approximately 5.42% of total body surface area. Using this ratio, the amount of expected moisture directly transferred to the practice surface is calculated as a fraction of the non-evaporated sweat loss. In the studied form, the Yoke Mat™ more effectively resists slipping than the PCV mat and cotton rug at water levels above 12.5 mL. This corresponds to an absorption rate of 125 mL·m-², which is range a large portion of practice styles and athletic abilities.

TABLE 6
Sweat Rate^{†} by style and Moisture Absorption

| | | Non-evaporated | Moisture Absorption |
|---|---|---|---|
| | | Sweat loss | for Practice Surface |
| Asana Style | Description | (g · m⁻² · h⁻¹) | (mL · m²) |
| Astanga | Vigorous | 25-560 | 6.0-151.8 |
| Bikram | Moderate, hot | 580-932 | 157.2-252.6 |
| Kundalini | Gentle | 0-50 | 0-13.5 |
| Iyengar | Moderate | 0-126 | 0-34.1 |
| Sivananda | Moderate | 0-126 | 0-34.1 |
| Viniyoga | Gentle | 0-50 | 0-13.5 |
| Vinyasa | Vigorous | 25-560 | 6.0-151.8 |

^{†}modified from Shapiro, et al^{21, 22}

The technical applicability of the Tapas® Mat is demonstrated in FIG. 7 for the adjusted sweat loss rates during a one hour course. The slightly-moist conditions of many practitioners require a slip force above the threshold. Yet, both the PVC mat and cotton rug fail to provide adequate slip resistance. Most practice in slight to moderate levels of absorbed perspiration, the Yoke Mat™ provides an effective and all natural solution. Vigorous routines of seasoned practitioners may also fall into an effective range. Material selection and fabrication specifications will address this deficiency and may significantly improve the slip force at lower loads and higher water levels.

In general, the health and performance motivations for a machine washable and dryable all-natural slip-resistant and absorbent fibrous material are shown. Effective coefficients of friction for three mats at different levels of absorbed water define the performance areas. The Yoke Mat™ offers resistance to slippage for most asana styles.

### CONCLUSION

Accordingly, the reader will see that the slip-resistant textile exercise and yoga mat of this invention can be used without risk of injury through lack of cushioning or slipping from pooled perspiration. Specifically, the textile mat has these advantages:
it provides sufficient cushioning from the increased number of twisted yarn and/or threads in one textile layer.
it permits safe practice conditions by providing a tacky bottom surface.
it permits safe practice conditions by providing a tacky top surface.
it prevents the practitioner's body from overheating as it absorbs excess perspiration and reflects heat back due to the properties of the slip-resistant coating.
it allows for easy care as it is machine washable and dryable.
it allows for many possible aesthetic thread and color combinations.

Although the description above contains many specifications, these should not be construed as limiting the scope of the invention as merely providing illustrations of some of the presently preferred embodiments of this invention. For example:
the use of a single textile layer can be made from a plurality of layers being laminated or stitched together. I found the additional cushioning was most easily provided through one textile layer.
slip-resistant surfaces can be obtained from other materials such as synthetic rubber, chemical slip-resistant coatings, laminated preformed slip-resistant meshes, stitched pre-formed molds, etc.
minimized amounts of slip-resistant coatings can be obtained from varied machine applications, such as an array of slip-resistant dots found on ordinary gardening or motorcycle gloves.
top surface disposed slip-resistant coating may not hinder some people's practice if they do not perspire. A light full or partial top spray that provides sufficient traction may minimally affect aesthetic value.
attached slip-resistant mesh can be used in lieu of detachable if placed and chain stitched or quilted in areas of high longitudinal stress. However, the mesh is difficult to attach and may rip off easily.
attached slip-resistant scrims can be approximated by disposition of liquid slip-resistant material or other aforementioned slip-resistant alternatives in predetermined locals.
the slip-resistant textile comprising of slip-resistant yarn and/or thread can be made with a combination of yarn and thread. Furthermore, a fiber that inherently has the property of being slip-resistant could be twisted into the weft thread rather than dipped cotton strands, such as elastic cord.

The preferred embodiment is the version includes individual strands of slip-resistant yarn and/or thread. This version provides the most amount of functionality using the least amount of resources.

Industrial applicability of this invention beyond a floor covering or exercise mat includes any type of application where slip-resistance and moisture-absorption is advantageous. In particular, uses such as filtration, composites, wipes, components for building and part assemblies, technical materials, and household goods.

Thus the scope of the invention should be determined by the written descriptions and their legal equivalents rather than by the examples given.

### REFERENCES

1 J A Kent, Riegel's Handbook of Industrial Chemistry, 10^{th} Edition, New York, Klewer Academic/Plenum Publishers, 2003.
2 J A Tickner, ‘Trends in World PVC Industry Expansion: a Greenpeace White Paper’, http://www.ecologycenter.org/iptf/plasti_types/TrendsinWorldPVC(GP).htm, Jun. 19, 1998.
3 J Wypych with A D Jenkins, editor, Polyvinyl Chloride Stabilization, Polymer Science Library 4, New York, Elsevier Science Publishing Company Inc., 1986.
4 S Hutchinson, ‘The Sticky in Your Mat,’ Yogi Times, Apr. 2004, 18.
5 C Kleiner, ‘Mind-body fitness,’ U.S. News & World Report, May 13, 2002 132(16).
6 F P Ruiz, ‘Sticky Business’, Yoga J, Winter 2000-2001.
7 J Cook, ‘Not All Yoga is Created Equal’, Yoga J, Winter 1999-2000.
8 C Winder, ‘The Toxicology of Chlorine’, Environmental Research Section A, 2001 85 105-114.
9 K A Graeme and C V Pollack, Jr., ‘Heavy Metal Toxicity, Part I: Arsenic and Mercury’, J Emergency Medicine, 1998 16(1) 45-56.
10 K A Graeme and C V Pollack, Jr., ‘Heavy Metal Toxicity, Part II: Lead and Metal Fume Fever’, J Emergency Medicine, 1998 16(2) 171-177.
11 D Kriebel, ‘The Dioxins: Toxic and Still Troublesome’, Environment, 1981 23(1) 6-13.
12 P F Infante, ‘Observations of the Site-Specific Carcinogenicity of Vinyl Chloride to Humans’, Environmental Health Perspectives, 1981 41 89-94.
13 W K Lelbach, ‘A 25-Year Follow-up Study of the Heavily Vinyl Chloride Exposed Workers in Germany’, American J of Industrial Medicine, 1996 29 446-458.
14 E D Owen, editor, Degradation and Stabilisation of PVC, London, Elsevier Applied Science Publishers, Ltd, 1984.
15 C F Wilkinson and J C Lamb IV, ‘The Potential Health Effects of Phthalate Esters in Children's Toys: A Review and Risk Assessment’, Regulatory Toxicology and Pharmacology, 1999 30 140-155.
16 R H Burgess, editor, Manufacture and Processing of PVC, New York, Macmillan Publishing Co., Inc., 1982.
17 F P La Mantia, editor, Recycling of PVC & Mixed Plastic Waste. Ontario, ChemTec Publishing, 1996.
18 A Whelan, and J L Craft, editors, Developments in PVC Production and Processing-1, London, Applied Science Publishers, Ltd., 1977.
19 J V Koleske and L H Wartman, Poly(Vinyl Chloride), New York, Gordon and Breach Science Publishers, 1969.
20—, ‘Sticky Yoga mats—Q and A’, Simply Yoga, www.simply-yoga.co.uk, article 17/120504.
21 G Gappert, J F Coates and I Leveson, Vinyl 2020: Progress, Challenges, Prospects for the Next Quarter Century, Morristown, N.J., The Vinyl Institute, 1996.
22 Y Shapiro, K B Pandolf, and R F Goldman, ‘Predicting Sweat Loss Response to Exercise, Environment and Clothing’, European J of Applied Physiology, 1982 48 83-96.
23 Y Shapiro, D Moran, Y Epstein, et al, ‘Validation and adjustment of the mathematical prediction model for human sweat rate responses to outdoor environmental conditions’, Ergonomics, 1995 38(5) 981-986.

The inventor claims:

1. A composite material comprising:
A single layer of slip-resistant and moisture-absorbent materials;

2. The composite material described in claim 1, wherein said slip-resistant materials is at least one material having a coefficient of kinetic friction larger than unity;

3. The composite material described in claim 2, wherein said slip-resistant materials comprise one or more natural at least one of natural and synthetic rubbers, plastics, and elastomers in the shape of one or more of fiber, filament, yarn, cord, tape, coating, miscible blend, immiscible blend, or mixtures thereof;

4. The composite material described in claim 1, wherein said moisture-absorbent materials is at least one material have a coefficient of kinetic friction of about unity;

5. The composite material described in claim 4, wherein said moisture-absorbent materials comprise at least one of natural materials including but not limited to cellulose, cotton, flax, linen, hemp, and kenaf in the shape of one or more of fiber, filament, yarn, cord, tape, or mixtures thereof;

6. The composite material described in claim 4, wherein said moisture-absorbent materials comprise at least one of synthetic materials including but not limited to rayon, bamboo, nylon, polyester, polyethylene, polypropylene, and acrylic in the shape of one or more of fiber, filament, yarn, cord, tape, coating, miscible blend, immiscible blend, or mixtures thereof;

7. The composite material described in claim 1, wherein said material is formed via a technique comprising extrusion, pultrusion, molding, blow-molding, injection-molding, nonwoven processing, weaving, or knitting;

8. The composite material described in claim 1, wherein said materials further comprise additives such as dyes, pigments, perfumes, odor enhancers, antibacterials, antifungals, UV absorbers, texturizers, finishing agents, plasticizers, and processing agents; and

9. The composite material described in claim 1, wherein a pattern is incorporated into the composite.

10. An exercise mat comprising a composite material comprising:
a single layer of slip-resistant and moisture-absorbent materials;

11. The exercise mat described in claim 10, wherein said slip-resistant materials is at least one material having a coefficient of kinetic friction larger than unity;

12. The exercise mat described in claim 11, wherein said slip-resistant materials comprise one or more natural and synthetic rubbers, plastics, and elastomers in the shape of one or more of fiber, filament, yarn, cord, tape, coating, miscible blend, immiscible blend, or mixtures thereof;

13. The exercise mat described in claim 10, wherein said moisture-absorbent materials is at least one material have a coefficient of kinetic friction of about unity;

14. The exercise mat described in claim 13, wherein said moisture-absorbent materials is of a natural source and comprises one or more cellulose, cotton, flax, linen, hemp, jute, and kenaf in the shape of one or more of fiber, filament, yarn, cord, tape, or mixtures thereof;

15. The exercise mat described in claim 13, wherein said moisture-absorbent materials comprise a synthetic source such as rayon, bamboo, nylon, polyester, polyethylene, polypropylene, acrylic, and blends thereof in the shape of fiber, filament, yarn, cord, tape, or mixtures thereof;

16. The exercise mat described in claim 10, wherein said material is formed via a technique comprising extrusion, pultrusion, molding, blow-molding, injection-molding, nonwoven processing, weaving, or knitting;

17. The exercise mat described in claim 10, wherein said materials further comprise additives such as dyes, pigments, perfumes, odor enhancers, antibacterials, antifungals, UV absorbers, texturizers, finishing agents, plasticizers, and processing agents;

18. The exercise mat described in claim 10, wherein an alignment pattern is incorporated into the composite;

19. The exercise mat described in claim 10, wherein said mat has a width of about 30-cm to about 100-cm, a length of about 100-cm to about 250-cm, and a depth of about 0.1 to about 5-cm; and

20. The exercise mat described in claim 10, wherein said mat retains its dimensions and properties after being washed and dried in a machine.
